(19) United States
(12) Patent Application Publication
(10) Pub. No.: US 2023/0334212 A1
(43) Pub. Date: Oct. 19, 2023

(54) Systems And Methods For Selecting Decoupling Capacitance Using A Power Jumper Circuit

(71) Applicant: Intel Corporation, Santa Clara, CA (US)

(72) Inventors: Md Altaf Hossain, Portland, OR (US); Mahesh Kumashikar, Bangalore (IN); Ankireddy Nalamalpu, Portland, OR (US)

(73) Assignee: Intel Corporation, Santa Clara, CA (US)

(21) Appl. No.: 18/207,842

(22) Filed: Jun. 9, 2023

(51) Int. Cl. G06F 30/373; H01L 23/64; H01L 23/50

(52) U.S. Cl. CPC G06F 30/373; H01L 23/642; H01L 23/50; G06F 2119/06

(57) ABSTRACT

An integrated circuit package includes a support device, first and second integrated circuits mounted on the support device, and a power jumper circuit selectable to couple a decoupling capacitor to one of a first power supply input of the first integrated circuit or a second power supply input of the second integrated circuit.

### TECHNICAL FIELD

This disclosure relates to electronic circuit systems and methods, and more particularly to systems and methods for selecting decoupling capacitance for an integrated circuit using a power jumper circuit.

### BACKGROUND ART

Many modern electronic circuit systems include integrated circuit (IC) packages. An integrated circuit (IC) package may contain multiple integrated circuit dies. The integrated circuit dies in an IC package may, for example, be mounted on an interposer or a package substrate.

### BRIEF DESCRIPTION OF DRAWINGS

FIG. 1 is a diagram that illustrates a top down view of an example of a circuit system that includes a support device and four integrated circuits (ICs).

FIG. 2 is a diagram that illustrates a top down view of another example of a circuit system that includes a support device and the four integrated circuits (ICs).

FIG. 3 illustrates an example of a programmable logic IC that can implement techniques disclosed herein.

### DETAILED DESCRIPTION

A supply voltage that is at a constant or nearly constant voltage is desired for optimal performance of an integrated circuit (IC). The amount of supply current drawn from a supply voltage may vary during the operation of an integrated circuit. The variations in the supply current can cause significant fluctuations in the supply voltage during operation.

Many integrated circuit designs require power supply networks to supply stable supply voltages for integrated circuits (ICs) operating at high data rates and high clock signal frequencies. Decoupling capacitors are often used to help provide more stable power supply voltages to circuits in integrated circuits. A decoupling capacitor shunts high frequency noise on a direct current (DC) power supply network to a ground network, thereby preventing noise from reaching circuits on an integrated circuit that receive the supply voltage. Decoupling capacitance acts as a store of charge that provides current to maintain a stable supply voltage during circuit operation.

During the operation of an integrated circuit, power usage of the integrated circuit may vary. For example, the integrated circuit may draw additional supply current when there is a change in the state of an internal circuit. Changes in the supply current consumption of the integrated circuit causes current fluctuations and creates unwanted supply voltage noise. A decoupling capacitor can be used to maintain a more constant supply voltage received by the integrated circuit. The decoupling capacitor serves as a local energy storage reserve that provides supply current for circuits in the integrated circuit. A decoupling capacitor can accommodate changing power demand during circuit operation. A decoupling capacitor reduces noise in the supply voltage.

An on-package decoupling (OPD) capacitor can provide decoupling capacitance to circuits in an integrated circuit that is housed in the same IC package as the OPD capacitor. The OPD capacitor is coupled to the integrated circuit through conductors in the IC package. However, if the conductors in the package have a significant amount of inductance, then the OPD capacitor may not provide a supply voltage to the integrated circuit that is stable enough to meet the operating specifications of circuits in the integrated circuit. IC packages are also referred to herein simply as packages.

Some electronic circuit systems include multiple integrated circuits (ICs) in the same package. As an example, two, three, four, or more ICs can be housed in the same package. The integrated circuits in the package can, for example, be coupled together through a package substrate, an interposer in the package, or an interconnection bridge. Each integrated circuit (IC) in a package may be coupled to a separate OPD capacitor. Each OPD capacitor in a package is sized in terms of capacitance for an expected signal frequency of the corresponding IC that the OPD capacitor is coupled to.

In some package applications, one or more of the ICs in the package may not be used. In a package application in which one or more ICs in the package are not used, a user may want to increase the frequency of one or more of the signals used in the operation of one or more of the other ICs in the package. However, the OPD capacitors are typically not sized to accommodate an increased signal frequency for one or more of the integrated circuits in the package without causing an undesirable increase in noise in the supply voltages provided to these one or more ICs.

According to some examples disclosed herein, an integrated circuit (IC) package includes integrated circuits (ICs) and decoupling capacitors. A separate supply voltage is provided to each of the ICs in the package. One or more of the supply voltages can be turned off (e.g., grounded) in applications in which the corresponding ICs in the package are not used. In applications in which each of the ICs in the package are used, each of the ICs in the package is coupled to one of the decoupling capacitors to reduce noise in the supply voltage provided to that IC. In an application in which one or more of the ICs in the package are not used, one or more of the decoupling capacitors that were originally added to the package for the unused ICs are instead coupled to one or more of the ICs in the package that are used through a power jumper circuit in the package. Using additional decoupling capacitors for the ICs in the package that are used enables these ICs to be operated at greater signal frequencies.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

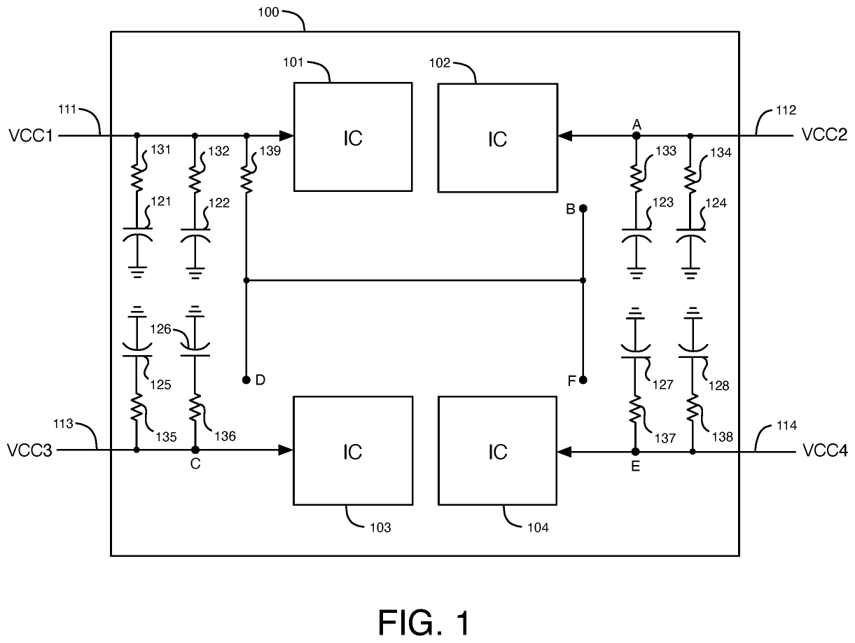

Figure (FIG. 1 is a diagram that illustrates a top down view of an example of a circuit system that includes a support device 100 and four integrated circuits (ICs) 101-104. The four integrated circuits 101-104 are dies that are mounted on, and coupled to, the support device 100 through connectors (not shown). The circuit system of FIG. 1 can be, for example, an integrated circuit (IC) package that houses ICs 101-104. Each of the ICs 101-104 can be any type of IC die, such as a programmable logic IC (e.g., a field programmable gate array or FPGA), a microprocessor IC, a graphics processing unit IC, a memory IC, an application specific IC, a transceiver IC, a memory IC, etc.

The support device 100 can be, for example, a package substrate or an interposer within an integrated circuit package. The support device 100 includes interconnection conductors (not shown) that couple the ICs 101-104 together through the connectors (e.g., conductive bumps). The circuit system of FIG. 1 also includes eight decoupling capacitors 121-128. Decoupling capacitors 121-128 can be OPD capacitors that are outside (i.e., external to) the support device 100 or embedded in the support device 100.

The support device 100 includes 6 external conductive terminals A-F (e.g., conductive pads) that are shown in FIG. 1, in addition to other external conductive terminals that are not shown in FIG. 1. The external conductive terminals are exposed on one or more surfaces of the support device 100. The external conductive terminals A-F are also referred to herein as external terminals.

The circuit system of FIG. 1 also includes 9 resistors 131-139. The resistors 131-139 can be, for example, outside (e.g., external to) the support device 100. In this example, the support device 100 is coupled to the external resistors 131-139 through external conductive terminals of the support device 100. In the example of FIG. 1, the resistors 133, 136, and 137 are outside the support device 100 and are coupled to the external terminals A, C, and E, respectively, of the support device 100. The resistors 131-139 can be, for example, coupled to external conductive terminals of the support device 100 on the top surface and/or the bottom surface of the support device 100.

In the example of FIG. 1, decoupling capacitors 123, 126, and 127 are coupled to the external conductive terminals A, C, and E of the support device 100 through resistors 133, 136, and 137, respectively, of the support device 100. Each of the decoupling capacitors 121-128 is coupled to a ground voltage (e.g., on a ground line in support device 100), as shown in FIG. 1.

A separate supply voltage is provided to a power supply input of each of the ICs 101-104 through a separate power supply network. Four separate supply voltages VCC1, VCC2, VCC3, and VCC4 are provided through four power supply networks 111, 112, 113, and 114 to power supply inputs of ICs 101, 102, 103, and 104, respectively, as shown in FIG. 1. Two of the resistors 131-138 are coupled to each of the power supply networks 111-114. Thus, resistors 131-132, resistors 133-134, resistors 135-136, and resistors 137-138 are coupled to power supply networks 111, 112, 113, and 114, respectively. Resistor 139 is coupled to power supply network 111. Each of the power supply networks 111-114 is in the support device 100.

Two of the decoupling capacitors 121-128 are coupled to each of the power supply networks in the example of FIG. 1. Decoupling capacitors 121-122 are coupled through resistors 131-132, respectively, to the power supply network 111 that provides the supply voltage VCC1 to the power supply input of IC 101. Decoupling capacitors 123-124 are coupled through resistors 133-134, respectively, to the power supply network 112 that provides the supply voltage VCC2 to the power supply input of IC 102. Decoupling capacitors 125-126 are coupled through resistors 135-136, respectively, to the power supply network 113 that provides the supply voltage VCC3 to the power supply input of IC 103. Decoupling capacitors 127-128 are coupled through resistors 137-138, respectively, to the power supply network 114 that provides the supply voltage VCC4 to the power supply input of IC 104.

The capacitances of the decoupling capacitors 121-128 are selected based on the expected operating frequencies of signals in the respective ICs 101-104. In some applications of the circuit system of FIG. 1, one or more of the ICs 101-104 may be not be used. In an application with one or more ICs that are unused in the circuit system, it may be advantageous to reprovision one or more of the decoupling capacitors 121-128 from one or more of the unused ICs to the one or more ICs that are used in the application so that the operating frequencies of signals in the one or more ICs that are used in the application can be increased. Reprovisioning decoupling capacitors from the one or more unused ICs to the one or more ICs that are used in the application can be achieved by coupling these decoupling capacitors to the one or more power supply networks that provide supply voltage(s) to the one or more ICs that are used in the application. These techniques allow the operating frequencies of signals in the one or more ICs that are used in the application to be increased without having to redesign and remanufacture the support device 100. Also, these techniques help to avoid overdesigning an expensive solution which may not be practical from a cost perspective.

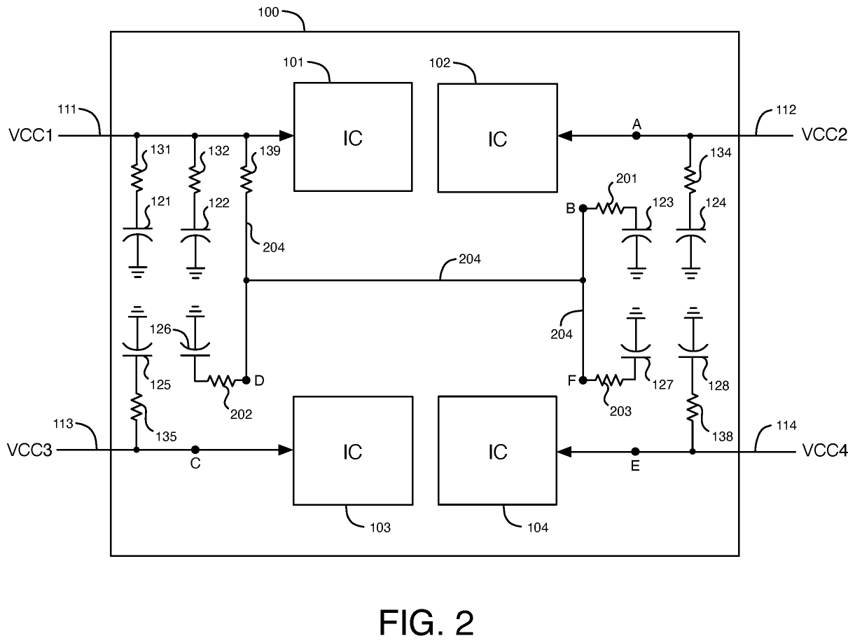

FIG. 2 is a diagram that illustrates a top down view of another example of a circuit system in which three of the decoupling capacitors shown in FIG. 1 have been reprovisioned to a different one of the ICs. In the circuit system of FIG. 2, the capacitances of the decoupling capacitors 121-128 have been selected based on the expected signal operating frequencies of the ICs 101-104. However, in the circuit system of FIG. 2, IC 101 has a greater signal operating frequency than the signal operating frequency that the 2 decoupling capacitors 121-122 were sized for in terms of capacitance. The 3 ICs 102, 103, and 104 are either not used in the circuit system of FIG. 2, or are operated at lower signal operating frequencies than the signal operating frequencies that the decoupling capacitors 123-128 were designed for. As a result, decoupling capacitors 123-128 are not needed by ICs 102-104 for decoupling capacitance. Instead of re-designing support device 100, the capacitors 123 and 126-127 are reprovisioned in the circuit system of FIG. 2 from ICs 102-104 to IC 101, so that the operating frequency of signals in IC 101 can be increased (e.g., from 200 MHz to 500 MHz).

Decoupling capacitors 123 and 126-127 are reprovisioned from ICs 102-104 to IC 101 by coupling capacitors 123 and 126-127 to the power supply network 111 that provides supply voltage VCC1 to IC 101 through additional resistors 201-203 and resistor 139. Resistors 201-203 and/or 139 can be, for example, external resistors that are coupled to the support device 100 through external conductive terminals of the support device 100. Each of the resistors 201-203 can be, for example, a resistor that has zero Ohms. Resistor 201 is coupled to decoupling capacitor 123. Resistor 202 is coupled to decoupling capacitor 126. Resistor 203 is coupled to decoupling capacitor 127. Resistors 201, 202, and 203 can be, for example, in the same three external components as the capacitors 123, 126, and 127, respectively, if capacitors 123 and 126-127 are three OPD capacitors.

In order to reprovision the decoupling capacitors 123 and 126-127 to IC 101, the decoupling capacitors 123, 126, and 127 are coupled through resistors 201, 202, and 203 to external conductive terminals B, D, and F, respectively, of the support device 100. The decoupling capacitors 123, 126, and 127 and the resistors 201-203 can be, for example, coupled to the external conductive terminals B, D, and F of the support device 100 on the top surface and/or the bottom surface of the support device 100.

Resistor 139 is coupled through interconnection conductors 204 in the support device 100 to resistor 201 at external terminal B, to resistor 202 at external terminal D, and to resistor 203 at external terminal F. Resistor 139 is coupled to power supply network 111.

In the circuit system of FIG. 2, the power supply network 111 and the power supply input of IC 101 are coupled to decoupling capacitor 126 through resistors 139 and 202. The power supply network 111 and the power supply input of IC 101 are coupled to decoupling capacitor 123 through resistors 139 and 201. The power supply network 111 and the power supply input of IC 101 are coupled to decoupling capacitor 127 through resistors 139 and 203. The power supply network 111 and the power supply input of IC 101 are coupled to decoupling capacitors 121-122 through resistors 131-132, respectively. Thus, the power supply network 111 and the power supply input of IC 101 are coupled to 5 decoupling capacitors 121-123, 126, and 127. As a result, the circuit system of FIG. 2 allows the operating frequency of signals in IC 101 to be increased without causing an undesirable increase in power supply noise in VCC1 and without having to redesign the support device 100.

The circuit systems of FIGS. 1-2 have power jumper circuits that are selectable to couple decoupling capacitors to different power supply networks. For example, resistor 133 or resistor 201 is a first power jumper circuit that is selectable to couple decoupling capacitor 123 to power supply network 112 through resistor 133 (as shown in FIG. 1) or to power supply network 111 through resistor 201 (as shown in FIG. 2), as described above. Resistor 136 or resistor 202 is a second power jumper circuit that is selectable to couple decoupling capacitor 126 to power supply network 113 through resistor 136 (as shown in FIG. 1) or to power supply network 111 through resistor 202 (as shown in FIG. 2), as described above. Resistor 137 or resistor 203 is a third power jumper circuit that is selectable to couple decoupling capacitor 127 to power supply network 114 through resistor 137 (as shown in FIG. 1) or to power supply network 111 through resistor 203 (as shown in FIG. 2), as described above.

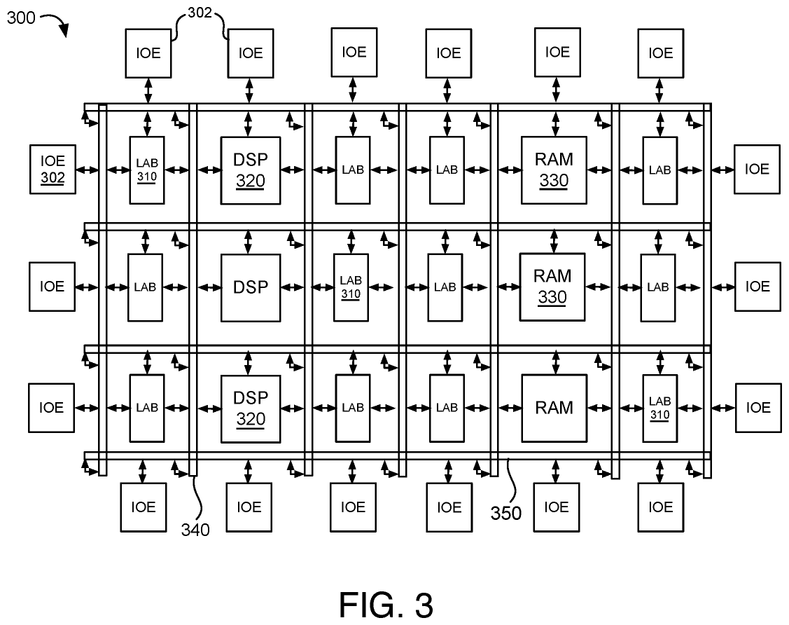

FIG. 3 illustrates an example of a programmable logic IC 300 that can implement techniques disclosed herein. Any one or more of the ICs 101-104 can include the architecture of programmable logic IC 300. As shown in FIG. 3, the programmable logic IC 300 includes a two-dimensional array of configurable functional circuit blocks, including configurable logic array blocks (LABs) 310 and other functional circuit blocks, such as random access memory (RAM) blocks 330 and digital signal processing (DSP) blocks 320. Functional blocks such as LABs 310 can include smaller programmable logic circuits (e.g., logic elements, logic blocks, or adaptive logic modules) that receive input signals and perform custom functions on the input signals to produce output signals.

In addition, programmable logic IC 300 can have input/output elements (IOEs) 302 for driving signals off of programmable logic IC 300 and for receiving signals from other devices. IOEs 302 may include parallel input/output circuitry, serial data transceiver circuitry, differential receiver and transmitter circuitry, or other circuitry used to connect one integrated circuit to another integrated circuit. As shown, IOEs 302 may be located around the periphery of the chip. If desired, the programmable logic IC 300 may have IOEs 302 arranged in different ways. For example, IOEs 302 may form one or more columns, rows, or islands of input/output elements that may be located anywhere on the programmable IC 300.

The programmable logic IC 300 can also include programmable interconnect circuitry in the form of vertical routing channels 340 (i.e., interconnects formed along a vertical axis of programmable logic IC 300) and horizontal routing channels 350 (i.e., interconnects formed along a horizontal axis of programmable logic IC 300), each routing channel including at least one track to route at least one wire.

Note that other routing topologies, besides the topology of the interconnect circuitry depicted in FIG. 3, may be used. For example, the routing topology may include wires that travel diagonally or that travel horizontally and vertically along different parts of their extent as well as wires that are perpendicular to the device plane in the case of three dimensional integrated circuits. The driver of a wire may be located at a different point than one end of a wire.

Furthermore, it should be understood that embodiments disclosed herein with respect to FIGS. 1-2 may be implemented in any integrated circuit or electronic system. If desired, the functional blocks of such an integrated circuit may be arranged in more levels or layers in which multiple functional blocks are interconnected to form still larger blocks. Other device arrangements may use functional blocks that are not arranged in rows and columns.

Programmable logic IC 300 may contain programmable memory elements. Memory elements may be loaded with configuration data using IOEs 302. Once loaded, the memory elements each provide a corresponding static control signal that controls the operation of an associated configurable functional block (e.g., LABs 310, DSP blocks 320, RAM blocks 330, or IOEs 302).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory bits of the row that was designated by the address register.

In certain embodiments, programmable logic IC 300 may include configuration memory that is organized in sectors, whereby a sector may include the configuration RAM bits that specify the functions and/or interconnections of the subcomponents and wires in or crossing that sector. Each sector may include separate data and address registers.

The programmable IC of FIG. 3 is merely one example of an IC that can include embodiments disclosed herein. The embodiments disclosed herein may be incorporated into any suitable integrated circuit or system. For example, the embodiments disclosed herein may be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPGAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now disclosed. Example 1 is an integrated circuit package comprising: a support device; first and second integrated circuits mounted on the support device; and a first power jumper circuit selectable to couple a first decoupling capacitor to one of a first power supply input of the first integrated circuit or a second power supply input of the second integrated circuit.

In Example 2, the integrated circuit package of Example 1 may optionally include, wherein the first power jumper circuit comprises: a resistor coupled between the first power supply input of the first integrated circuit and the first decoupling capacitor.

In Example 3, the integrated circuit package of Example 1 may optionally include, wherein the first power jumper circuit comprises: a resistor coupled between the second power supply input of the second integrated circuit and the first decoupling capacitor.

In Example 4, the integrated circuit package of any one of Examples 1-3 may optionally include, wherein the support device comprises: a first external terminal coupled to the first power supply input of the first integrated circuit; and a second external terminal coupled to the second power supply input of the second integrated circuit, wherein the first power jumper circuit couples the first decoupling capacitor to one of the first external terminal or the second external terminal.

In Example 5, the integrated circuit package of any one of Examples 1˜4 may optionally include, wherein the first decoupling capacitor is an on-package decoupling capacitor.

In Example 6, the integrated circuit package of any one of Examples 1-5 further comprises: a third integrated circuit mounted on the support device; and a second power jumper circuit selectable to couple a second decoupling capacitor to one of the first power supply input of the first integrated circuit or a third power supply input of the third integrated circuit.

In Example 7, the integrated circuit package of Example 6 may optionally include, wherein the second power jumper circuit comprises: a resistor coupled between the first power supply input of the first integrated circuit and the second decoupling capacitor.

In Example 8, the integrated circuit package of Example 6 may optionally include, wherein the second power jumper circuit comprises: a resistor coupled between the third power supply input of the third integrated circuit and the second decoupling capacitor.

In Example 9, the integrated circuit package of any one of Examples 1-8 further comprises: a resistor coupled between the first power supply input of the first integrated circuit and the first power jumper circuit.

Example 10 is a support device comprising: a first power supply network configured to be coupled to a first integrated circuit; a second power supply network configured to be coupled to a second integrated circuit, wherein the support device is configured to support the first integrated circuit and the second integrated circuit; a first external terminal coupled to the first power supply network; and a second external terminal coupled to the second power supply network, wherein a first power jumper circuit couples a first decoupling capacitor to one of the first power supply network through the first external terminal or the second power supply network through the second external terminal.

In Example 11, the support device of Example 10 may optionally include, wherein the first power jumper circuit comprises a resistor that couples the first decoupling capacitor to the first power supply network.

In Example 12, the support device of Example 10 may optionally include, wherein the first power jumper circuit comprises a resistor that couples the first decoupling capacitor to the second power supply network.

In Example 13, the support device of any one of Examples 10-12 further comprises: a third power supply network configured to be coupled to a third integrated circuit; a third external terminal coupled to the first power supply network; and a fourth external terminal coupled to the third power supply network, wherein a second power jumper circuit couples a second decoupling capacitor to one of the first power supply network through the third external terminal or the third power supply network through the fourth external terminal.

In Example 14, the support device of Example 13 may optionally include, wherein the second power jumper circuit comprises a resistor that couples the second decoupling capacitor to the first power supply network or to the third power supply network.

Example 15 is a method for selecting decoupling capacitance in an integrated circuit package, the method comprising: mounting first and second integrated circuits on a support device in the integrated circuit package; and coupling a first decoupling capacitor to one of a first power supply input of the first integrated circuit or a second power supply input of the second integrated circuit through a first power jumper circuit.

In Example 16, the method of Example 15 may optionally include, wherein coupling the first decoupling capacitor to one of the first power supply input of the first integrated circuit or the second power supply input of the second integrated circuit through the first power jumper circuit comprises coupling the first decoupling capacitor to one of the first power supply input of the first integrated circuit through a first external terminal of the support device or the second power supply input of the second integrated circuit through a second external terminal of the support device.

In Example 17, the method of any one of Examples 15-16 further comprises: mounting a third integrated circuit on the support device; and coupling a second decoupling capacitor to one of the first power supply input of the first integrated circuit or a third power supply input of the third integrated circuit through a second power jumper circuit.

In Example 18, the method of Example 17 further comprises: mounting a fourth integrated circuit on the support device; and coupling a third decoupling capacitor to one of the first power supply input of the first integrated circuit or a fourth power supply input of the fourth integrated circuit through a third power jumper circuit.

In Example 19, the method of any one of Examples 16-18 may optionally include, wherein coupling the first decoupling capacitor to one of the first power supply input of the first integrated circuit or the second power supply input of the second integrated circuit through the first power jumper circuit comprises coupling the first decoupling capacitor to one of the first power supply input of the first integrated circuit or the second power supply input of the second integrated circuit through a resistor.

In Example 20, the method of any one of Examples 15-19 may optionally include, wherein the support device is a package substrate.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

1. An integrated circuit package comprising:
a support device;
first and second integrated circuits mounted on the support device; and
a first power jumper circuit selectable to couple a first decoupling capacitor to one of a first power supply input of the first integrated circuit or a second power supply input of the second integrated circuit.

2. The integrated circuit package of claim 1, wherein the first power jumper circuit comprises:
a resistor coupled between the first power supply input of the first integrated circuit and the first decoupling capacitor.

3. The integrated circuit package of claim 1, wherein the first power jumper circuit comprises:
a resistor coupled between the second power supply input of the second integrated circuit and the first decoupling capacitor.

4. The integrated circuit package of claim 1, wherein the support device comprises:
a first external terminal coupled to the first power supply input of the first integrated circuit; and
a second external terminal coupled to the second power supply input of the second integrated circuit, wherein the first power jumper circuit couples the first decoupling capacitor to one of the first external terminal or the second external terminal.

5. The integrated circuit package of claim 1, wherein the first decoupling capacitor is an on-package decoupling capacitor.

6. The integrated circuit package of claim 1 further comprising:
a third integrated circuit mounted on the support device; and
a second power jumper circuit selectable to couple a second decoupling capacitor to one of the first power supply input of the first integrated circuit or a third power supply input of the third integrated circuit.

7. The integrated circuit package of claim 6, wherein the second power jumper circuit comprises:
a resistor coupled between the first power supply input of the first integrated circuit and the second decoupling capacitor.

8. The integrated circuit package of claim 6, wherein the second power jumper circuit comprises:
a resistor coupled between the third power supply input of the third integrated circuit and the second decoupling capacitor.

9. The integrated circuit package of claim 1 further comprising:
a resistor coupled between the first power supply input of the first integrated circuit and the first power jumper circuit.

10. A support device comprising:
a first power supply network configured to be coupled to a first integrated circuit;
a second power supply network configured to be coupled to a second integrated circuit, wherein the support device is configured to support the first integrated circuit and the second integrated circuit;
a first external terminal coupled to the first power supply network; and
a second external terminal coupled to the second power supply network, wherein a first power jumper circuit couples a first decoupling capacitor to one of the first power supply network through the first external terminal or the second power supply network through the second external terminal.

11. The support device of claim 10, wherein the first power jumper circuit comprises a resistor that couples the first decoupling capacitor to the first power supply network.

12. The support device of claim 10, wherein the first power jumper circuit comprises a resistor that couples the first decoupling capacitor to the second power supply network.

13. The support device of claim 10 further comprising:
a third power supply network configured to be coupled to a third integrated circuit;
a third external terminal coupled to the first power supply network; and
a fourth external terminal coupled to the third power supply network, wherein a second power jumper circuit couples a second decoupling capacitor to one of the first power supply network through the third external terminal or the third power supply network through the fourth external terminal.

14. The support device of claim 13, wherein the second power jumper circuit comprises a resistor that couples the second decoupling capacitor to the first power supply network or to the third power supply network.

15. A method for selecting decoupling capacitance in an integrated circuit package, the method comprising:
mounting first and second integrated circuits on a support device in the integrated circuit package; and
coupling a first decoupling capacitor to one of a first power supply input of the first integrated circuit or a second power supply input of the second integrated circuit through a first power jumper circuit.

16. The method of claim 15, wherein coupling the first decoupling capacitor to one of the first power supply input of the first integrated circuit or the second power supply input of the second integrated circuit through the first power jumper circuit comprises coupling the first decoupling capacitor to one of the first power supply input of the first integrated circuit through a first external terminal of the support device or the second power supply input of the second integrated circuit through a second external terminal of the support device.

17. The method of claim 15 further comprising:
mounting a third integrated circuit on the support device; and
coupling a second decoupling capacitor to one of the first power supply input of the first integrated circuit or a third power supply input of the third integrated circuit through a second power jumper circuit.

18. The method of claim 17 further comprising:
mounting a fourth integrated circuit on the support device; and
coupling a third decoupling capacitor to one of the first power supply input of the first integrated circuit or a fourth power supply input of the fourth integrated circuit through a third power jumper circuit.

19. The method of claim 16, wherein coupling the first decoupling capacitor to one of the first power supply input of the first integrated circuit or the second power supply input of the second integrated circuit through the first power jumper circuit comprises coupling the first decoupling capacitor to one of the first power supply input of the first integrated circuit or the second power supply input of the second integrated circuit through a resistor.

20. The method of claim 15, wherein the support device is a package substrate.
